(19) United States
(12) Patent Application Publication
(10) Pub. No.: US 2012/0164520 A1
(43) Pub. Date: Jun. 28, 2012

(54) Electrode Assembly and Secondary Battery Including Electrode Assembly

(75) Inventor: Kyugil Choi, Yongin-si (KR)

(73) Assignee: SAMSUNG SDI CO., LTD., Yongin-si (KR)

(21) Appl. No.: 13/267,968

(22) Filed: Oct. 7, 2011

(30) Foreign Application Priority Data
Dec. 24, 2010 (KR) 10-2010-0134393

(51) Int. Cl. H01M 4/00; H01M 2/02

(52) U.S. Cl. 429/163; 429/211

(57) ABSTRACT

An electrode assembly and a secondary battery including the same. The electrode assembly includes a plurality of positive electrode plates including a first positive electrode plate including a first positive electrode tab arranged at a first location, and a second positive electrode plate including a second positive electrode tab arranged at a second location, a plurality of negative electrode plates; and a separator arranged between ones of the positive electrode plates and ones of the negative electrode plates, wherein the first positive electrode plate and the second positive electrode plate are alternately stacked.

### CLAIM OF PRIORITY

This application makes reference to, incorporates the same herein, and claims all benefits accruing under 35 U.S.C. §119 from an application for Electrode Assembly and Secondary Battery Including Electrode Assembly earlier filed in the Korean Intellectual Priority Office on 24 Dec. 2010 and there duly assigned Serial No. 10-2010-0134393.

### BACKGROUND OF THE INVENTION

1. Field of the Invention

A design for an electrode assembly and a secondary battery including the electrode assembly that results in less stress and less damage to the separators and the battery as a whole due to the welding of the tabs to the lead plates.

2. Description of the Related Art

A stack-type electrode assembly is formed by stacking positive electrode plates, separators, and negative electrode plates. The positive electrode plates include positive electrode tabs, and the negative electrode plates include negative electrode tabs. The positive electrode tabs are coupled to a lead tab, for example, using supersonic welding, and thus, are electrically connected thereto. The negative electrode tabs are coupled to a lead tab, for example, using supersonic welding, and thus, are electrically connected thereto.

As the capacity of a secondary battery increases, the number of the positive and negative electrode plates to be stacked increases. Accordingly, a large amount of supersonic power is required to weld the positive and negative electrode tabs, which may damage other parts of the electrode assembly.

### SUMMARY OF THE INVENTION

An aspect of the present invention provides an electrode assembly and a high capacity secondary battery including the electrode assembly, which make it possible to efficiently weld stacked positive and negative electrode plates of the secondary battery.

According to at least one of embodiments, an electrode assembly includes a plurality of positive electrode plates including a first positive electrode plate including a first positive electrode tab arranged at a first location, and a second positive electrode plate including a second positive electrode tab arranged at a second location, a plurality of negative electrode plates and a separator arranged between ones of the positive electrode plates and ones of the negative electrode plates, wherein the first positive electrode plate and the second positive electrode plate are alternately stacked.

Adjacent sides of the first positive electrode tab and the second positive electrode tab may contact each other from a plan view. The first positive electrode tab and the second positive electrode tab may be arranged at a side of the positive electrode plates with respect to a longitudinal axis of the positive electrode plates. The first positive electrode tab and the second positive electrode tab may be coupled to a positive lead by a weld produced by a supersonic welding process. The first positive electrode tab and the second positive electrode tab may be welded to the positive lead have arc shapes corresponding to each other from a side view of the positive electrode plates. The positive lead may have a width ranging from about 100% to about 120% of a sum of a width of the first positive electrode tab and a width of the second positive electrode tab. The negative electrode plates may include a first negative electrode plate including a first negative electrode tab arranged at a third location and a second negative electrode plate including a second negative electrode tab arranged at a fourth location. Adjacent sides of the first negative electrode tab and the second negative electrode tab may contact each other from a plan view. The first negative electrode tab and the second negative electrode tab may be arranged at a side of the negative electrode plates with respect to a longitudinal axis of the negative electrode plates. The first negative electrode tab and the second negative electrode tab may be coupled to a negative lead by a weld produced by a supersonic welding process.

The first negative electrode tab and the second negative electrode tab may be coupled to the negative lead via the weld have arc shapes corresponding to each other from a side view of the negative electrode plate. The negative lead may have a width ranging from about 100% to about 120% of a sum of a width of the first negative electrode tab and a width of the second negative electrode tab. The first positive electrode tab and the second positive electrode tab may be arranged at a side of the electrode assembly with respect to a longitudinal axis of the electrode assembly, and the first negative electrode tab and the second negative electrode tab may be arranged at an other side of the electrode assembly with respect to the longitudinal axis of the electrode assembly. The first positive electrode tab and the second positive electrode tab may not overlap each other. The first negative electrode tab and the second negative electrode tab may not overlap each other.

According to another aspect of the present invention, there is provided a secondary battery that includes a case and an electrode assembly that includes a plurality of positive electrode plates including a first positive electrode plate including a first positive electrode tab arranged at a first location, and a second positive electrode plate including a second positive electrode tab arranged at a second location, a plurality of negative electrode plates and a separator arranged between ones of the positive electrode plates and ones of the negative electrode plates, wherein the first positive electrode plate and the second positive electrode plate are alternately stacked.

The negative electrode plates may include a first negative electrode plate including a first negative electrode tab arranged at a third location and a second negative electrode plate including a second negative electrode tab arranged at a fourth location. The case may include a main body including a pouch-shaped portion to accommodate the electrode assembly and an electrolyte and a flange surrounding the pouch-shaped portion and a cover adhered to the flange of the main body to seal within the electrode assembly and the electrolyte. The secondary battery may also include a positive lead and a negative lead extending to an outside of the case, the first positive electrode tab and the second positive electrode tab may each be connected to the positive lead by a weld, the first negative electrode tab and the second negative electrode tab may each be connected to the positive lead by a weld. Each of the welds may be produced by a supersonic welding process.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings which like reference symbols indicate the same or similar components, wherein:

FIG. 1 is a perspective view illustrating an electrode assembly according to an embodiment;

FIG. 2 is a plan view illustrating an electrode assembly according to an embodiment;

FIG. 3 is a perspective view illustrating a secondary battery including an electrode assembly according to an embodiment;

FIG. 4 is a cross-sectional view taken along line A-A′ of FIG. 3; and

FIG. 5 is a plan view illustrating an electrode assembly according to another embodiment.

### DETAILED DESCRIPTION OF THE INVENTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Hereinafter, embodiments will be described in detail with reference to the accompanying drawings.

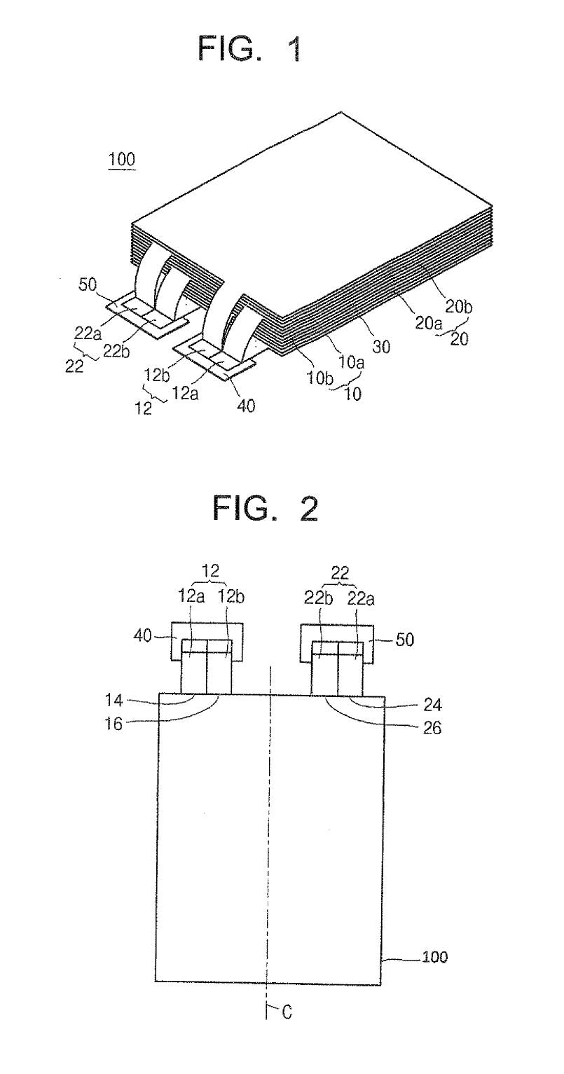

Turning now to FIGS. 1 and 2, FIG. 1 is a perspective view illustrating an electrode assembly 100 according to an embodiment and FIG. 2 is a plan view illustrating an electrode assembly 100 according to an embodiment. Referring now to FIGS. 1 and 2, an electrode assembly 100 according to an embodiment includes positive electrode plates 10, negative electrode plates 20, separators 30, a positive lead 40, and a negative lead 50.

Each positive electrode plate 10 is formed by forming a positive electrode coating portion (not shown) on both side surfaces of a positive electrode collector. The positive electrode coating portion includes a layered compound containing lithium, a binder that increases coupling force, and a conductor that improves conductivity.

Each positive electrode plate 10 includes a positive electrode tab 12 that protrudes from a portions of the positive electrode plate 10, and the positive electrode coating portion (not shown) is not formed on the positive electrode tab 12.

The positive electrode plates 10 include the first and second positive electrode plates 10a and 10b. The positive electrode tabs 12 may be disposed at a first location 14 and at a second location 16. The positive electrode tab 12 disposed at the first location 14 is referred to as a first positive electrode tab 12a, and the positive electrode plate 10 attached to the first positive electrode tab 12a is referred to as a first positive electrode plate 10a. The positive electrode tab 12 disposed at the second location 16 is referred to as a second positive electrode tab 12b, and the positive electrode plate 10 attached to the second positive electrode tab 12b is referred to as a second positive electrode plate 10b. Accordingly, the first location 14 and the second location 16 may be described using the first positive electrode tab 12a and the second positive electrode tab 12b, respectively.

The first and second positive electrode tabs 12a and 12b are arranged at one side of the upper portion of the positive electrode plates 10 with respect to a longitudinal axis C passing through the center of the positive electrode plates 10. In more detail, the first positive electrode tab 12a is spaced a certain distance from the left side of the positive electrode plates 10.

The second positive electrode tab 12b is disposed on a same side of longitudinal axis C at the upper portion of the positive electrode plate 10 as the first positive electrode tab 12a, and is adjacent to the longitudinal axis C. When the first positive electrode tab 12a and the second positive electrode tab 12b are stacked, the first positive electrode tab 12a contacts the second positive electrode tab 12b through adjacent sides thereof, as illustrated in FIG. 2. However, the first positive electrode tab 12a and the second positive electrode tab 12b do not overlap each other.

Since the first positive electrode tab 12a contacts the second positive electrode tab 12b through the adjacent sides thereof, when vertical force is applied to a surface of the first or second positive electrode tab 12a or 12b, frictional force generated at a contact between the adjacent sides prevents drooping of the first or second positive electrode tab 12a or 12b. Thus, breakage of the first or second positive electrode tab 12a or 12b can be prevented.

The negative electrode plates 20 are the same in size (width and length) and shape as the positive electrode plates 10, and each are produced by forming a negative electrode coating portion (not shown) on both side surfaces of a negative electrode collector. The negative electrode coating portion includes carbon and a binder that improves coupling force between active particles and carbon or graphite.

The negative electrode plates 20 include negative electrode tabs 22 that protrude from portions of the negative electrode plates 20, and the negative electrode coating portion (not shown) is not formed on the negative electrode tabs 22. The negative electrode tabs 22 may be disposed at a third location 24 and a fourth location 26 on the negative electrode plates 20. The negative electrode plates 20 include the first and second negative electrode plates 20a and 20b. The negative electrode tab 22 disposed at the third location 24 is referred to as a first negative electrode tab 22a, and the negative electrode plate 20 including the first negative electrode tab 22a is referred to as a first negative electrode plate 20a. The negative electrode tab 22 disposed at the fourth location 26 is referred to as a second negative electrode tab 22b, and the negative electrode plate 20 including the second negative electrode tab 22b is referred to as a second negative electrode plate 20b. Accordingly, the third location 24 and the fourth location 26 may be described using the first negative electrode tab 22a and the second negative electrode tab 22b, respectively.

The first and second negative electrode tabs 22a and 22b are disposed on an opposite side of longitudinal axis C than first and second positive electrode tabs 12a and 12b. Hereinafter, it is assumed that the first and second negative electrode tabs 22a and 22b are disposed on a right side of the upper portion of the negative electrode plates 20 with respect to the longitudinal axis C passing through the center of the negative electrode plates 20.

In more detail, the first negative electrode tab 22a is spaced a certain distance from the right side of the negative electrode plates 20. The second negative electrode tab 22b is disposed at the side of the upper portion of the negative electrode plates 20, like the first negative electrode tab 22a, and is adjacent to the longitudinal axis C. When the first negative electrode tab 22a and the second negative electrode tab 22b are stacked, the first negative electrode tab 22a contacts the second negative electrode tab 22b through adjacent sides thereof, as illustrated in FIG. 2. However, the first negative electrode tab 22a and the second negative electrode tab 22b do not overlap.

As a result, the first and second positive electrode tabs 12a and 12b are disposed on one side of the longitudinal axis C, and the first and second negative electrode tabs 22a and 22b are disposed on the other side of the longitudinal axis C.

Since the first negative electrode tab 22a contacts the second negative electrode tab 22b through the adjacent sides thereof, when vertical force is applied to a surface of the third or second negative electrode tab 22a or 22b, frictional force generated at a contact between the adjacent sides prevents drooping of the third or second negative electrode tab 22a or 22b. Thus, breakage of the third or second negative electrode tab 22a or 22b can be prevented.

In addition, since the first positive electrode tab 12a contacts the second positive electrode tab 12b through the adjacent sides thereof, and the first negative electrode tab 22a contacts the second negative electrode tab 22b through the adjacent sides thereof, the second positive electrode tab 12b is prevented from crossing the longitudinal axis C, thereby preventing a short circuit due to a contact between the second positive electrode tab 12b and the second negative electrode tab 22b. Conversely, the second negative electrode tab 22b is prevented from crossing the longitudinal axis C, thereby preventing a short circuit due to a contact between the second positive electrode tab 12b and the second negative electrode tab 22b. Furthermore, the width of the positive lead 40 connected to the first and second positive electrode tabs 12a and 12b, and the width of the negative lead 50 connected to the first and second negative electrode tabs 22a and 22b can be decreased, and thus, the positive lead 40 and the negative lead 50 are prevented from crossing the longitudinal axis C, thereby suppressing a short circuit due to a contact between the positive lead 40 and the negative lead 50.

The separator 30 is disposed between ones of the positive electrode plates 10 and ones of the negative electrode plates 20 to electrically insulate the positive and negative electrode plates 10 and 20 while allowing charges to pass between the positive and negative electrode plates 10 and 20.

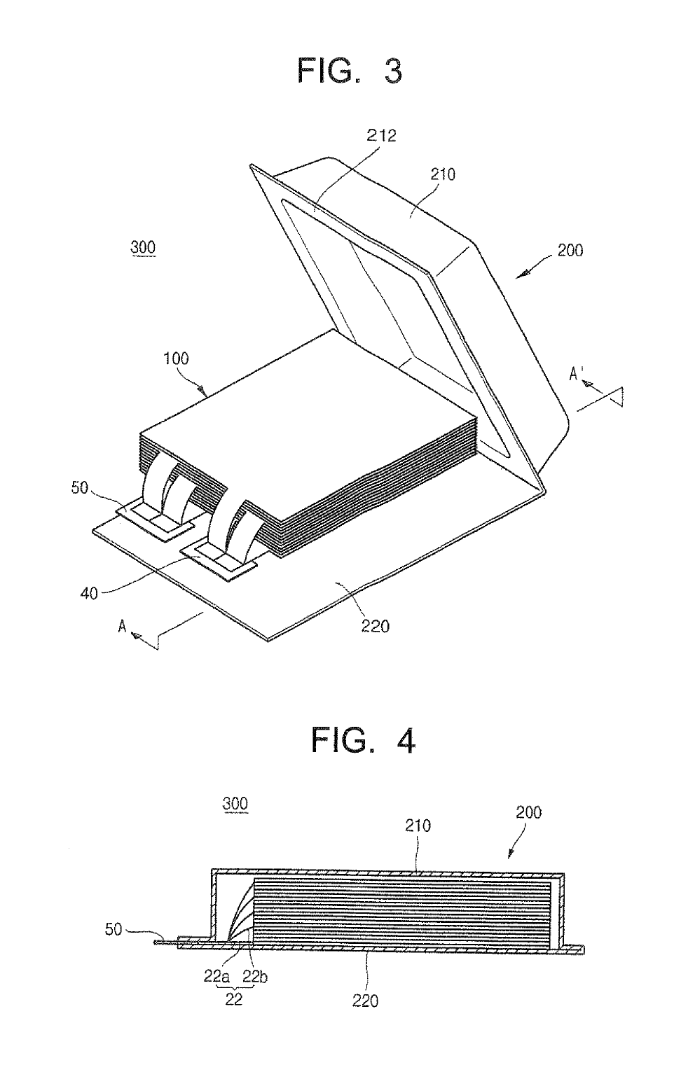

Stacking of the positive electrode plates 10, the negative electrode plates 20, and the separators 30 will now be described with reference to FIG. 3.

In the electrode assembly 100, the first and second positive electrode plates 10a and 10b are alternately stacked, and the first and second negative electrode plates 20a and 20b are alternately stacked.

In more detail, a process of sequentially stacking the first positive electrode plate 10a, the separator 30, the first negative electrode plate 20a, the separator 30, the second positive electrode plate 10b, the separator 30, and the second negative electrode plate 20b is repeated at several times.

Although one of the positive electrode plates 10, the separator 30, and one of the negative electrode plates 20 are sequentially stacked, since the first and second positive electrode plates 10a and 10b are the positive electrode plates 10, the order of the first and second positive electrode plates 10a and 10b may be reversed. Also, since the first and second negative electrode plates 20a and 20b are the negative electrode plates 20, the order thereof may be reversed.

In the electrode assembly 100 formed through the stacking process as described above, the first positive electrode tabs 12a and the second positive electrode tabs 12b are welded independently, for example, by a supersonic welding technique. Also, the first negative electrode tabs 22a and the second negative electrode tabs 22b are welded independently, for example, by a supersonic welding technique.

The positive and negative electrode tabs 12 and 22 are made out of aluminum (Al) and copper (Cu), respectively. With these materials, a welding process with aluminum (Al) and a welding process with copper (Cu) can be performed at about 660° C. and about 1000° C., respectively. Thus, a welding process for the negative electrode tab 22 is more difficult than a welding process for the positive electrode tab 12, and the amount of heat emitted from the negative electrode tab 22 is greater than that of the positive electrode tab 12.

Thus, when a group of the positive electrode tabs 12 and a group of the negative electrode tabs 22 are welded independently, the positive electrode tabs 12 and the negative electrode tabs 22 are slimed and a less amount of energy is consumed than in a case where the positive electrode tabs 12 and the negative electrode tabs 22 are formed at the same location.

Since the positive electrode tabs 12 and the negative electrode tabs 22 are welded with a small amount of energy, damage to the separator 30 can be prevented, and supersonic transmission to the electrode assembly 100 is reduced, which prevents separation of active material from the positive electrode plates 10 and the negative electrode plates 20, thereby preventing an increase of active material as a foreign material within the electrode assembly 100.

Since the welded positive and negative electrode tabs 12 and 22 are slim, coupling force thereof is increased to prevent a separation of welded surfaces after the welding.

The positive lead 40 is electrically connected to the first positive electrode tab 12a and the second positive electrode tab 12b using a technique such as welding to electrically connect the first and second positive electrode tabs 12a and 12b to the exterior of the electrode assembly 100. In this case, the welding may be supersonic welding.

The negative lead 50 is electrically connected to the first negative electrode tab 22a and the second negative electrode tab 22b using a method such as welding, to electrically connect the first and second negative electrode tabs 22a and 22b to the exterior of the electrode assembly 100. In this case, the welding may be supersonic welding.

When the first and second positive electrode tabs 12a and 12b are welded to the positive lead 40, the first and second positive electrode tabs 12a and 12b may have arc shapes from a side view of the positive electrode plate 10. When the first and second negative electrode tabs 22a and 22b are welded to the negative lead 50, the first and second negative electrode tabs 22a and 22b may have arc shapes from a side view of the negative electrode plate 20.

Since the arc shapes are determined according to a welding location when the positive electrode tabs 12 and the negative electrode tabs 22 are welded to the positive lead 40 and to the negative lead 50 respectively, the shapes thereof from the side views are not limited to the arc shapes.

The positive lead 40 may have a minimum width that is equal (about 100%) to the sum of the widths of the first positive electrode tab 12a and the second positive electrode tab 12b. Alternatively, the positive lead 40 may have a width that is greater than the sum of the widths of the first positive electrode tab 12a and the second positive electrode tab 12b. However, when the width of the positive lead 40 is too large, the positive lead 40 may cross the longitudinal axis C passing through the center of the positive or negative electrode plate 10 or 20 to contact the negative lead 50, thereby causing a short circuit. Thus, the maximum width of the positive lead 40 may be about 120% of the sum of the widths of the first positive electrode tab 12a and the second positive electrode tab 12b.

For the same reason, the width of the negative lead 50 may range about 100% to about 120% of the sum of the widths of the first negative electrode tab 22a and the second negative electrode tab 22b.

Hereinafter, a secondary battery including an electrode assembly according to an embodiment will now be described. Turning now to FIGS. 3 and 4, FIG. 3 is a perspective view illustrating a secondary battery 300 including an electrode assembly 100 according to an embodiment and FIG. 4 is a cross-sectional view taken along line A-A′ of FIG. 3.

Referring now to FIGS. 3 and 4, a secondary battery 300 according to an embodiment may include the electrode assembly 100 and a case 200. Since the electrode assembly 100 is previously described, a description thereof will be omitted here.

The case 200 includes a main body 210 that has a pouch-shape to accommodate the electrode assembly 100 and has an inner space to be filled with electrolyte, and a cover 220 that is integrally formed with the main body 210 and extends from an end of the main body 210. A flange 212 is disposed around an edge of the main body 210. The flange 212 is adhered to the cover 220 to seal the main body 210.

When the electrode assembly 100 is placed within the case 200, the positive lead 40 and the negative lead 50 protrude to an outside of the case 200. In this scenario, an insulating film (not shown) may be attached to a portion of the positive and negative leads 40 and 50 contacting the flange 212 of the case 200.

Since a process of alternately stacking and welding the first and second positive electrode plates 10a and 10b provided with the first and second positive electrode tabs 12a and 12b is performed independently from a process of alternately stacking and welding the first and second negative electrode plates 20a and 20b provided with the first and second negative electrode tabs 22a and 22b, the positive electrode tabs 12 are separated from the negative electrode tabs 22 in the secondary battery 300.

Thus, welding thicknesses of the positive electrode tabs 12 and the negative electrode tabs 22 are decreased, thereby reducing welding power during a welding process. The amount of heat generated by welding in the electrode assembly 100 is reduced, thereby preventing damage to the separator 30, and the welding power is reduced to decrease the amount of supersonic transmission to the electrode assembly 100, thereby preventing separation of active material from the positive electrode plates 10 and the negative electrode plates 20, and preventing an increase of active material as foreign material within the electrode assembly 100.

A stacking number of the positive electrode tabs 12 and the negative electrode tabs 22 constituting the electrode assembly 100 is divided, and thus, is reduced to prevent a separation of welded surfaces after the positive electrode tabs 12 and the negative electrode tabs 22 are welded.

According to the embodiment, since the positive electrode tabs are disposed respectively at the first and second locations and are alternately stacked, and the negative electrode tabs are disposed respectively at the third and fourth locations and are alternately stacked, because the welding thicknesses of the positive and negative electrode tabs is reduced, the welding power is reduced, and thus, the amount of generated heat is also reduced, thereby preventing damage to the separators. In addition, the welding power is reduced, thereby reducing the amount of supersonic transmission to the electrode assembly, thereby preventing separation of active material from the positive electrode plates and the negative electrode plates, and thus preventing an increase of active material as foreign material within the electrode assembly.

According to the embodiment, since the positive electrode tabs are disposed respectively at the first and second locations and are alternately stacked, and the negative electrode tabs are disposed respectively at the third and fourth locations and are alternately stacked, to decrease the welding thicknesses of the positive and negative electrode tabs, a stacking number of the positive electrode tabs and the negative electrode tabs constituting the electrode assembly is divided, and thus, is reduced to prevent a separation of welded surfaces after the positive electrode tabs and the negative electrode tabs are welded.

An electrode assembly according to another embodiment will now be described.

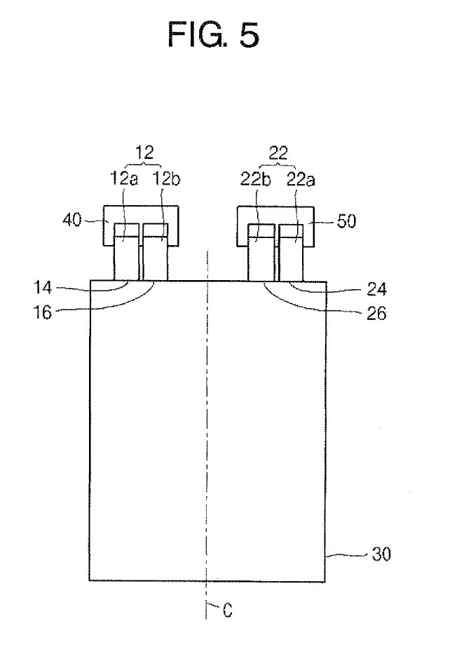

Turning now to FIG. 5, FIG. 5 is a plan view illustrating an electrode assembly according to another embodiment. Referring to FIG. 5, an electrode assembly according to another embodiment is substantially the same as the electrode assembly 100 according to an embodiment, except that a first positive electrode tab 12a and a second positive electrode tab 12b are separated from each other and a first negative electrode tab 22a and a second negative electrode tab 22b are separated from each other. Thus, the components that have the same function as those shown in the drawings of the previous embodiment are referred to as the same reference numerals and the repeated description thereof will not be given.

The first positive electrode tab 12a and the second positive electrode tab 12b may not overlap each other. In more detail, adjacent sides of the first positive electrode tab 12a and the second positive electrode tab 12b may be spaced apart from each other.

In addition, the first negative electrode tab 22a and the second negative electrode tab 22b may not overlap each other. In more detail, adjacent sides of the first negative electrode tab 22a and the second negative electrode tab 22b may be spaced apart from each other.

Therefore, in the electrode assembly according to another embodiment, like in the electrode assembly 100 according to an embodiment, when the first and second positive electrode tabs 12a and 12b are connected to a positive lead 40, or when the first and second negative electrode tabs 22a and 22b are connected to a negative lead 50, welding thicknesses of the positive electrode tabs 12 and the negative electrode tabs 22 are decreased, thereby reducing welding power during a welding process. Accordingly, damage to a separator 30 can be prevented. In addition, separation of active material from the positive electrode plates 10 and the negative electrode plates 20 can be prevented.

Meanwhile, since adjacent sides of the first positive electrode tab 12a and the second positive electrode tab 12b or the first negative electrode tab 22a and the second negative electrode tab 22b are spaced apart from each other, compared to a case where adjacent sides thereof contact each other from a plan view, the electrode assembly according to another embodiment can be efficiently formed.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure as set forth in the following claims.

What is claimed is:

1. An electrode assembly, comprising:
a plurality of positive electrode plates including a first positive electrode plate including a first positive electrode tab arranged at a first location, and a second positive electrode plate including a second positive electrode tab arranged at a second location;
a plurality of negative electrode plates; and
a separator arranged between ones of the positive electrode plates and ones of the negative electrode plates, wherein the first positive electrode plate and the second positive electrode plate are alternately stacked.

2. The electrode assembly of claim 1, wherein adjacent sides of the first positive electrode tab and the second positive electrode tab contact each other from a plan view.

3. The electrode assembly of claim 1, wherein the first positive electrode tab and the second positive electrode tab are arranged at a side of the positive electrode plates with respect to a longitudinal axis of the positive electrode plates.

4. The electrode assembly of claim 1, wherein the first positive electrode tab and the second positive electrode tab are coupled to a positive lead by a weld produced by a supersonic welding process.

5. The electrode assembly of claim 4, wherein the first positive electrode tab and the second positive electrode tab welded to the positive lead have arc shapes corresponding to each other from a side view of the positive electrode plates.

6. The electrode assembly of claim 4, wherein the positive lead has a width ranging from about 100% to about 120% of a sum of a width of the first positive electrode tab and a width of the second positive electrode tab.

7. The electrode assembly of claim 1, wherein the negative electrode plates comprise:
a first negative electrode plate including a first negative electrode tab arranged at a third location; and
a second negative electrode plate including a second negative electrode tab arranged at a fourth location.

8. The electrode assembly of claim 7, wherein adjacent sides of the first negative electrode tab and the second negative electrode tab contact each other from a plan view.

9. The electrode assembly of claim 7, wherein the first negative electrode tab and the second negative electrode tab are arranged at a side of the negative electrode plates with respect to a longitudinal axis of the negative electrode plates.

10. The electrode assembly of claim 7, wherein the first negative electrode tab and the second negative electrode tab are coupled to a negative lead by a weld produced by a supersonic welding process.

11. The electrode assembly of claim 10, wherein the first negative electrode tab and the second negative electrode tab coupled to the negative lead via the weld have arc shapes corresponding to each other from a side view of the negative electrode plate.

12. The electrode assembly of claim 10, wherein the negative lead has a width ranging from about 100% to about 120% of a sum of a width of the first negative electrode tab and a width of the second negative electrode tab.

13. The electrode assembly of claim 7, wherein the first positive electrode tab and the second positive electrode tab are arranged at a side of the electrode assembly with respect to a longitudinal axis of the electrode assembly, and the first negative electrode tab and the second negative electrode tab are arranged at an other side of the electrode assembly with respect to the longitudinal axis of the electrode assembly.

14. The electrode assembly of claim 1, wherein the first positive electrode tab and the second positive electrode tab do not overlap each other.

15. The electrode assembly of claim 8, wherein the first negative electrode tab and the second negative electrode tab do not overlap each other.

16. A secondary battery, comprising:
a case; and
an electrode assembly that includes:
a plurality of positive electrode plates including a first positive electrode plate including a first positive electrode tab arranged at a first location, and a second positive electrode plate including a second positive electrode tab arranged at a second location;
a plurality of negative electrode plates; and
a separator arranged between ones of the positive electrode plates and ones of the negative electrode plates, wherein the first positive electrode plate and the second positive electrode plate are alternately stacked.

17. The secondary battery of claim 16, wherein the negative electrode plates comprise:
a first negative electrode plate including a first negative electrode tab arranged at a third location; and
a second negative electrode plate including a second negative electrode tab arranged at a fourth location.

18. The secondary battery of claim 16, the case comprises:
a main body including a pouch-shaped portion to accommodate the electrode assembly and an electrolyte and a flange surrounding the pouch-shaped portion; and
a cover adhered to the flange of the main body to seal within the electrode assembly and the electrolyte.

19. The secondary battery of claim 17, further comprising a positive lead and a negative lead extending to an outside of the case, the first positive electrode tab and the second positive electrode tab each being connected to the positive lead by a weld, the first negative electrode tab and the second negative electrode tab each being connected to the positive lead by a weld.

20. The secondary battery of claim 19, each of the welds being produced by a supersonic welding process.
